(19) United States
(12) Patent Application Publication
(10) Pub. No.: US 2017/0028652 A1
(43) Pub. Date: Feb. 2, 2017

(54) MONOLITHIC PRIMARY STRUCTURAL PART FOR AIRCRAFT AND PROCESSES FOR MANUFACTURING IT

(71) Applicant: Airbus Operations S.L., Getafe (ES)

(72) Inventors: Carlos Garcia Nieto, Getafe (ES); Francisco Javier Honorato Ruiz, Getafe (ES)

(21) Appl. No.: 15/224,079

(22) Filed: Jul. 29, 2016

(30) Foreign Application Priority Data
Jul. 29, 2015 (EP) 15382393.5

(51) Int. Cl. B29C 70/54; B32B 5/26; G01N 3/08; B64C 1/00; G01N 3/24; B29C 70/34; B32B 17/06

(52) U.S. Cl. CPC B29C 70/54; B29C 70/34; B32B 5/26; B32B 17/067; B64C 1/00; G01N 3/24; G01N 3/08; B29K 2105/06

(57) ABSTRACT

A monolithic primary structural part for an aircraft made of carbon fiber composite material and glass fiber composite material and covered completely by at least one glass fiber ply on an external face of the structural part which includes carbon fiber plies. A method to determine the glass fiber composite plies in a monolithic primary structural part for aircraft, which includes calculating a number of glass fiber plies using a Damage Tolerance criteria for sizing structural parts, in which a number of glass fiber plies replace carbon fiber plies.

### RELATED APPLICATION

This application claims priority to European patent application 15382393.5 filed Jul. 29, 2015, the entirety of which is incorporated by reference.

### FIELD OF INVENTION

The present invention relates to a monolithic primary structural part for aircraft, e.g., those external parts of the aircraft that are likely to be damaged by external impacts, and to processes for manufacturing such part.

### BACKGROUND OF INVENTION

At present and especially in the aeronautical industry, materials comprising organic matrix and continuous fibers are used on a massive scale, such as, in particular, Carbon Fiber Reinforced Polymers or CFRP, and in a wide range of diverse structural elements.

For example, all of the elements comprising the load transfer boxes of the aircraft lifting surfaces (ribs, stringers, spars and skins), can be manufactured using CFRP.

Including glass fiber plies in the external areas of the structural parts provides a number of advantages (for instance, it avoids delaminations at back-movement of a riveting tool), so some specific areas of these structural parts are covered with glass fiber plies.

Some composite structures have the form of a sandwich structure, with a core element and outer layers comprising carbon fiber and glass fiber layers, as the one disclosed in US 2010/0055384 A1.

However, one of the disadvantages of using glass fiber is its high weight compared with that of carbon fiber, as weight is a very important factor to be taken into account in aircraft construction.

Damage Tolerance criteria is widely considered in the process for sizing the structural parts in aircraft. “Energy level” and “detectability” constitute two key variables for establishing when a structural part must sustain Ultimate Load (UL) or K*Limit Load (LL).

Monolithic primary structural parts made of carbon fiber that are able to offer a proper damage tolerance must have a relatively large thickness. Besides that, detectability in carbon fiber is usually more difficult than desired.

### SUMMARY OF INVENTION

An invention has been conceived and disclosed herein to provide a monolithic primary structural part for aircraft that solves the above-mentioned drawbacks.

The invention may provide a monolithic primary structural part for aircraft, made of carbon fiber composite material and glass fiber composite material, covered completely by at least one glass fiber ply on its external face over multiple carbon fiber plies.

The invention may also provide a process for manufacturing said monolithic primary structural part for aircraft, made of carbon fiber composite material and glass fiber composite material of the invention, which comprises calculating the number of glass fiber plies through the following steps:

(a) a carbon fiber monolithic primary structural part of thickness less than 3 mm (a thin part) is taken as a reference structural part, with a detectability-energy curve according to the Damage Tolerance criteria, and with a detectability threshold horizontal border,

(b) determination of the impact energy for the reference structural part as the cut point between the detectability-energy curve and the detectability threshold horizontal border,

(c) application of the impact energy of b) to the reference structural part and performance of Compression After Impact test, Tension After Impact Test or Shear After Impact test on the reference structural part,

(d) forming several specimens of structural parts as a result of removing different thicknesses of external carbon fiber plies in the reference structural part and replacing them with glass fiber plies, so that the weight of the removed carbon fiber plies is greater than the weight of the introduced glass fiber plies, and the delaminated area is equivalent to the detectability threshold,

(e) performance of Compression After Impact test if Compression After Impact Test was performed in step c), Tension After Impact Test if Tension After Impact Test was performed in step c) or Shear After Impact Test if Shear After Impact Test was performed in step c), on the specimens obtained in d), and

(f) obtention of the preferred specimen with a Compression After Impact equal or bigger than the Compression After Impact of the reference structural part if Compression After Impact Test was performed in steps c) and e) with a Tension After Impact equal or bigger than the Tension After Impact of the reference structural part if Tension After Impact Test was performed in steps c) and e) or with a Shear After Impact equal or bigger than the Shear After Impact of the reference structural part if Shear After Impact Test was performed in steps c) and e), the preferred specimen containing a number of glass fiber plies replacing a number of carbon fiber plies.

The invention may also provide a process for manufacturing said monolithic primary structural part for aircraft, made of carbon fiber composite material and glass fiber composite material of the invention, which comprises calculating the number of glass fiber plies through the following steps:

(a) a carbon fiber monolithic primary structural part of thickness greater than 3 mm (a thick part) is taken as a reference structural part, with a detectability-energy curve according to the Damage Tolerance criteria, and with a realistic energy vertical border,

(b) determination of the impact energy for the reference structural part as the cut point between the detectability-energy curve and the realistic energy vertical border,

(c) application of the impact energy of b) to the reference structural part and performance of Compression After Impact test, Tension After Impact Test or Shear After Impact test on the reference structural part,

(d) forming several specimens of structural parts as a result of removing different thicknesses of external carbon fiber plies in the reference structural part and replacing them with glass fiber plies, so that the weight of the removed carbon fiber plies is greater than the weight of the introduced glass fiber plies,

(e) performance of Compression After Impact test if Compression After Impact Test was performed in step c), Tension After Impact Test if Tension After Impact Test was performed in step c) or Shear After Impact Test if Shear After Impact Test was performed in step c), on the specimens obtained in d), and

(f) obtention of the preferred specimen with a Compression After Impact equal or bigger than the Compression After Impact of the reference structural part if Compression After Impact Test was performed in steps c) and e), with a Tension After Impact equal or bigger than the Tension After Impact of the reference structural part if Tension After Impact Test was performed in steps c) and e) or with a Shear After Impact equal or bigger than the Shear After Impact of the reference structural part if Shear After Impact Test was performed in steps c) and e), the preferred specimen containing a number of glass fiber plies replacing a number of carbon fiber plies.

The invention may provide one or more of the following advantages:

(i) Increase Damage Tolerance allowable for the Damage Tolerance criteria.

(ii) Weight saving associated with the sizing optimization of those structural parts sized by the Damage Tolerance criteria, and

(iii) Significant cost saving as a consequence of the already mentioned weight saving.

The solution provided by an embodiment of the invention provides an unexpected effect of weight saving, as glass fibers are heavier than carbon fibers, and a lighter part is obtained by adding glass fibers according to the invention.

### SUMMARY OF DRAWINGS

For a more complete understanding of the present invention, it will be described below in greater detail, making reference to the attached drawings, in which:

FIG. 1 is a graph that summarizes the Damage Tolerance criteria, including the corresponding thresholds.

FIG. 2 is a graph showing the Damage Tolerance for a thin part with no glass fiber plies.

FIG. 3 is a graph showing the Damage Tolerance for a thin part with glass fiber plies.

FIG. 4 is a graph showing the Damage Tolerance for a thick part with glass fiber plies.

FIG. 5 illustrates a carbon fiber monolithic primary structural part.

FIG. 6 illustrates a specimen of the carbon fiber monolithic primary structural part having at least one glass fiber ply.

### DETAILED DESCRIPTION OF INVENTION

For the purpose of this document, it will be considered that a “thin part” is a part with thickness less than 3 mm, and that a “thick part” is a part with thickness greater than 3 mm.

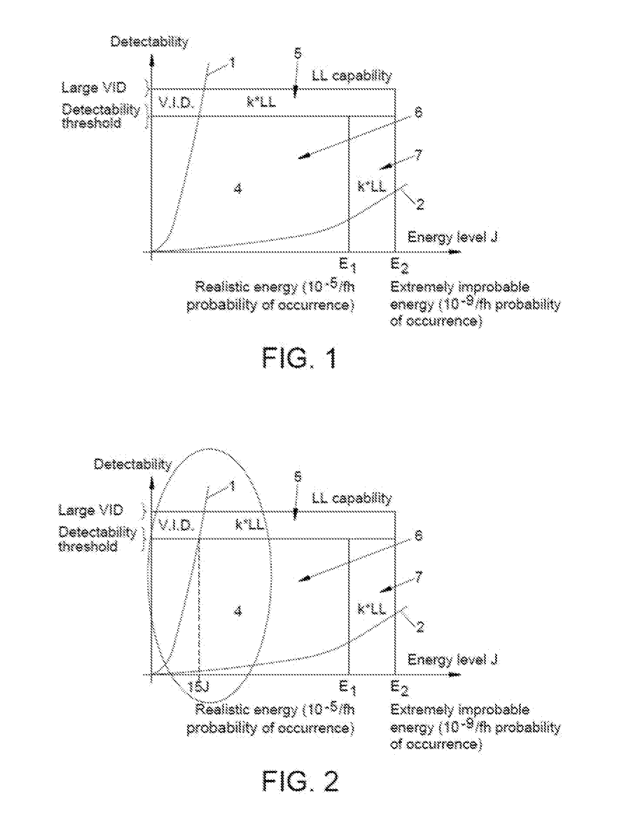

FIG. 1 illustrates the fundamentals of the Damage Tolerance criteria. Damage Tolerance criteria is widely used in the process for sizing the structural parts in aircraft.

As it can be seen in FIG. 1, “energy level” and “detectability” constitute two key variables for establishing when a structural part must sustain Ultimate Load (UL) or K*Limit Load (LL).Talking about “energy levels”, some typical recommended impact threats and associated energy thresholds are defined for each structural element or component. Talking about “detectability”, some inspection types are summarized as follows:

SPECIAL DETAILED INSPECTION (SDI): An intensive examination of a specific item, installation, or assembly to detect damage, failure or irregularity. The examination is likely to make extensive use of specialized Inspection Techniques and/or equipment. Intricate cleaning and substantial access or disassembly procedure may be required. When such inspections are required, detailed NDT procedures are described in the Non Destructive Testing Manual (NTM).

DETAILED VISUAL INSPECTION (DET): Close-proximity, intense visual inspection of relatively localized areas of internal and/or external structure. Appropriate access to gain proximity is required. Available lighting is normally supplemented with a direct source of good lighting at an intensity deemed appropriate. Inspection aids and techniques may be more sophisticated (e.g. lenses, grazing light on a clean element) and surface cleaning may also be necessary.

GENERAL VISUAL INSPECTION (GVI): Careful visual examination of relatively large areas of internal and/or external structure. This level of inspection is made within touching distance unless otherwise specified. Appropriate access to gain proximity (e.g. removal of fairings and access doors, use of ladders or work stands) is required. Inspection aids (e.g. mirrors) and surface cleaning may also be necessary. This level of inspection is made under normally available lighting condition such as daylight, hangar lighting, flash lighting or droplight.

WALK-AROUND (WA): Long distance visual inspection conducted from ground to detect large area of indentation or fibre breakage, i.e. readily detectable damage.

Based on these inspection types, for each structural element or component, different detectability thresholds are defined.

The following areas are defined in FIGS. 1 to 4:

1: Static requirements—UL must be sustained.

2:Detectable damage due to impacts up to extremely improbable energy levels.

3: Undetectable damage due to impacts up to realistic energy levels.

4: Undetectable damage due to impacts up to extremely improbable energy levels—Damage tolerance requirements: k*LL must be sustained.

In FIGS. 1 to 4, V.I.D. stands for Visual Inspection Detection.

Coming back to FIG. 1, the fundamentals of the Damage Tolerance approach is based on the next guidelines:

For a given structural part with a specific thickness and stacking sequence, the curve “Detectability-Energy” will be determined. In FIG. 1, for example, one curve 1 is shown for a thin part and another curve 2 for a thick part.

The curve 1, 2 will cut the Realistic Energy vertical border curve or the Detectability threshold horizontal border curve.

Depending on which curve is cut, the Damage Tolerance allowable will correspond to the “Energy criteria” or to the “Detectability criteria”. This Damage Tolerance allowable will come from a specific CAI (Compression After Impact) /TAI (Tension After Impact) /SAI (Shear After Impact) test (normally the first one—CAI—) associated with the energy where the curve 1, 2 crosses one or the other border.

In addition to the well-known advantages of including glass fiber plies in the external areas of the different structural parts (for example, avoiding delaminations at back-movement of riveting tool), some additional benefits associated with the sizing processes, dominated by Damage Tolerance criteria, can be reached. These benefits have to do with significant weight and cost savings.

The procedure to determine the number of glass fiber plies to be placed instead of carbon fiber plies will be detailed below.

When a thin part is involved, the detectability criteria is applied, and the number of glass fiber plies that cover the carbon fiber material is determined according to the following empirical process using the Damage Tolerance criteria for sizing structural parts:

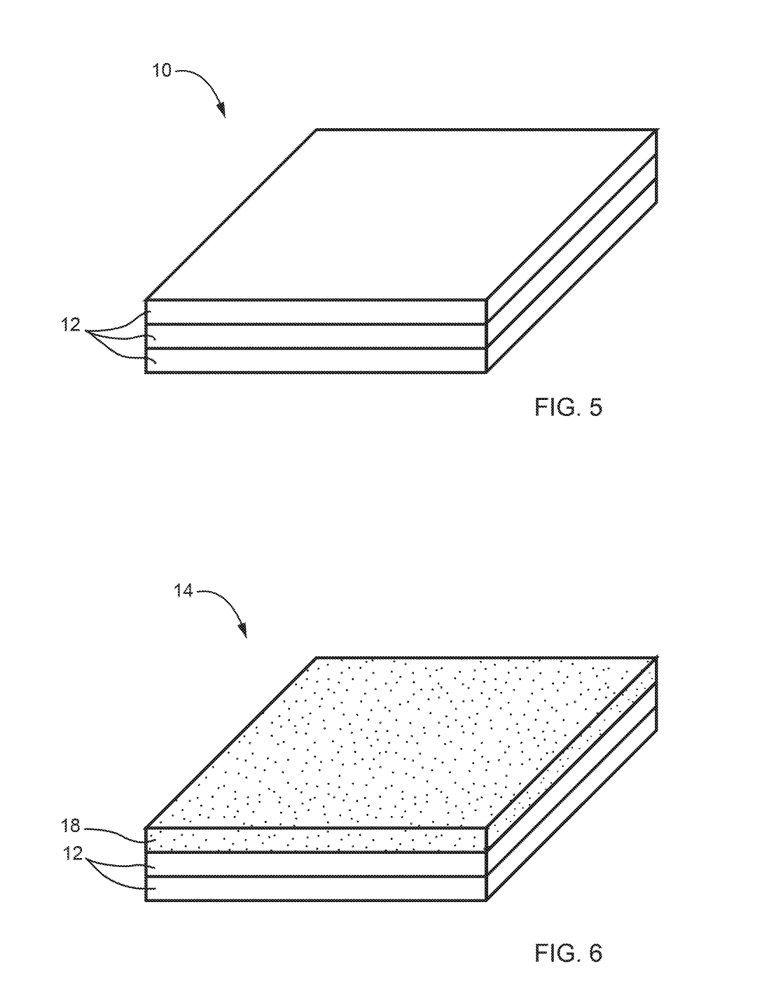

(a) a carbon fiber monolithic primary structural part 10 (FIG. 5) formed of plies of carbon fiber plies 12, wherein the structural part 10 has a thickness less than 3 mm is taken as a reference structural part, with a detectability-energy curve according to the Damage Tolerance criteria, and with a detectability threshold horizontal border,

(b) determination of the impact energy for the reference structural part as the cut point between the detectability-energy curve and the detectability threshold horizontal border,

(c) application of the impact energy of b) to the reference structural part and performance of Compression After Impact test, Tension After Impact Test or Shear After Impact Test on the reference structural part,

(d) forming several specimens 14 (FIG. 6) of the carbon fiber monolithic primary structural part by removing different thicknesses or number of one or more external carbon fiber plies 12 and replacing the removed carbon fiber ply or plies with glass fiber plies 18 (shown by speckling in FIG. 6), so that the weight of the removed carbon fiber plies is greater than the weight of the introduced glass fiber plies, and the delaminated area is equivalent to the detectability threshold. The delamination of the plies may be performed to remove from the stack one or more of the carbon fiber plies which are embedded in a resin matrix. The removed carbon fiber ply or plies may be the upper (or lower) ply or plies of the stack 14 monolithic primary structural part

(e) performance of Compression After Impact test if Compression After Impact Test was performed in step c), Tension After Impact Test if Tension After Impact Test was performed in step c) or Shear After Impact Test if Shear After Impact Test was performed in step c), on the specimens obtained in d), and

(f) obtention, e.g., selecting, of the preferred specimen 14 with a Compression After Impact equal or bigger than the Compression After Impact of the reference structural part if Compression After Impact Test was performed in steps c) and e), with a Tension After Impact equal or bigger than the Tension After Impact of the reference structural part if Tension After Impact Test was performed in steps c) and e), or with a Shear After Impact equal or bigger than the Shear After Impact of the reference structural part if Shear After Impact Test was performed in steps c) and e), the preferred specimen containing a number of glass fiber plies replacing a number of carbon fiber plies.

When a thick part is involved, the energy criteria is applied, and the number of glass fiber plies that cover the carbon fiber material is determined according to the following empirical process using the Damage Tolerance criteria for sizing structural parts:

(a) a carbon fiber monolithic primary structural part of thickness greater than 3 mm is taken as a reference structural part, with a detectability-energy curve according to the Damage Tolerance criteria, and with a realistic energy vertical border,

(b) determination of the impact energy for the reference structural part as the cut point between the detectability-energy curve and the realistic energy vertical border,

(c) application of the impact energy of b) to the reference structural part and performance of Compression After Impact test, Tension After Impact Test or Shear After Impact test on the reference structural part,

(d) forming several specimens of structural parts as a result of removing different thicknesses of external carbon fiber plies in the reference structural part and replacing them with glass fiber plies, so that the weight of the removed carbon fiber plies is greater than the weight of the introduced glass fiber plies,

(e) performance of Compression After Impact test if Compression After Impact Test was performed in step c), Tension After Impact Test if Tension After Impact Test was performed in step c) or Shear After Impact Test if Shear After Impact Test was performed in step c),on the specimens obtained in d), and

(f) obtention, e.g., selection, of the preferred specimen with a Compression After Impact equal or bigger than the Compression After Impact of the reference structural part if Compression After Impact Test was performed in steps c) and e), with a Tension After Impact equal or bigger than the Tension After Impact of the reference structural part if Tension After Impact Test was performed in steps c) and e) or with a Shear After Impact equal or bigger than the Shear After Impact of the reference structural part if Shear After Impact Test was performed in steps c) and e), the preferred specimen containing a number of glass fiber plies replacing a number of carbon fiber plies.

The invention will be better illustrated by means of several examples. The following information will be considered in the examples:

Consider typical area sized by Damage Tolerance criteria.

Material: Carbon Fiber Prepreg, Ply Thickness 0.25 mm.

Glass fiber; Ply thickness 0.25 mm.

Assessments are included here for thin and thick parts.

### EXAMPLE 1

### Thin Part

A carbon fiber monolithic primary structural part of a thickness of 2.5 mm (10 plies of 0.25 mm) is taken as a reference structural part, with a detectability-energy curve according to the Damage Tolerance criteria, and with a detectability threshold horizontal border. GVI (General Visual Inspection) is taken as inspection procedure. The cut point between the detectability-energy curve and the detectability threshold horizontal border determines an impact energy of 15 J for the reference structural part.

If the external composite ply is changed by glass fiber ply, a new specimen is obtained and it is possible that the GVI procedure can detect the damage at a lower value of energy than before, for example, at 8 J.

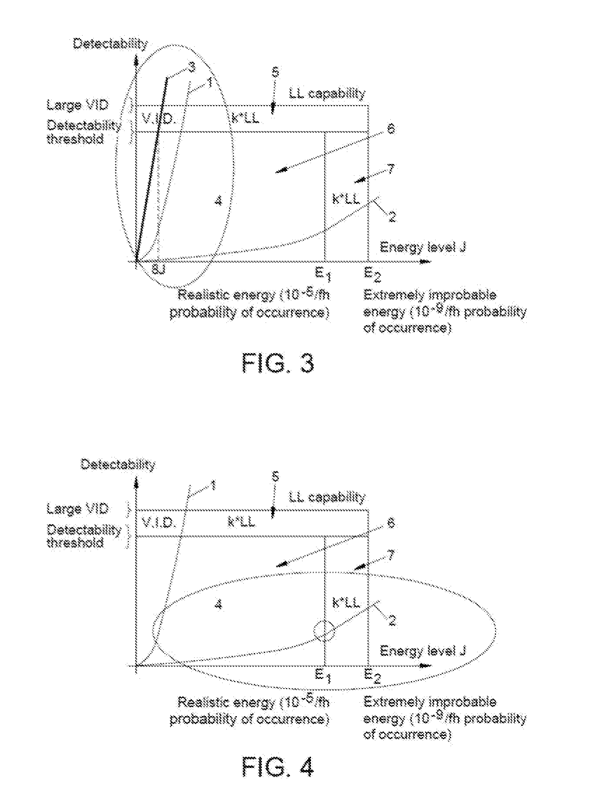

The Compression After Impact test (normally), the Tension After Impact Test or the Shear After Impact Test are performed on the reference structural part and on the specimen with glass fiber in order to get the allowable. If these allowables are better in the second case (lower energy and best impact structural behaviour, already shown in structural tests), than in the first case, weight and cost saving can be reached, in spite of the weight penalty given by the glass fiber in comparison with the carbon fiber one. FIGS. 2 and 3 illustrate this rationale: FIG. 2 corresponds to the thin part with no glass fiber ply, and FIG. 3 corresponds to the thin part with glass fiber ply (curve 3).

The preferred specimen contains a number of glass fiber plies replacing a number of carbon fiber plies.

### EXAMPLE 2

### Thick Part

A carbon fiber monolithic primary structural part of a thickness of 10 mm (40 plies of 0.25 mm) is taken as a reference structural part, with a detectability-energy curve according to the Damage Tolerance criteria, and with a realistic energy vertical border. GVI (General Visual Inspection) is taken as inspection procedure.

If the external composite ply is changed by glass fiber ply, a new specimen is obtained.

The Compression After Impact test (normally), the Tension After Impact Test or the Shear After Impact Test are performed on the reference structural part and on the specimen with glass fiber in order to get the allowable. If these allowables are better in the second case than in the first case, weight and cost saving can be reached, in spite of the weight penalty given by the glass fiber in comparison with the carbon fiber one. FIG. 4 illustrates this rationale.

The preferred specimen contains a number of glass fiber plies replacing a number of carbon fiber plies.

Although the present invention has been fully described in connection with preferred embodiments, it is evident that modifications may be introduced within the scope thereof, not considering this as limited by these embodiments, but by the contents of the following claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A monolithic primary structural part for aircraft, made of carbon fiber composite material and glass fiber composite material, wherein the monolithic primary structural part is covered completely by at least one glass fiber ply on an external face of the monolithic primary structural part and covers over multiple carbon fiber plies.

2. A method for selecting plies to manufacture a monolithic primary structural part for an aircraft, wherein the monolithic primary structural part is made of carbon fiber composite material and glass fiber composite material, wherein the method includes calculating a number of glass fiber plies by:
a) designating a carbon fiber monolithic primary structural part having a thickness less than 3 mm as a reference structural part, with a detectability-energy curve according to a Damage Tolerance criteria, and with a detectability threshold horizontal border,
b) determining an impact energy for the reference structural part as a cut point between a detectability-energy curve and a detectability threshold horizontal border,
c) application of the impact energy to the reference structural part and performance of a Compression After Impact test, a Tension After Impact Test or a Shear After Impact test on the reference structural part,
d) forming several specimens of structural parts as a result of removing different thicknesses of external carbon fiber plies in the reference structural part and replacing the removed external carbon fiber plies with glass fiber plies, so that a weight of the removed carbon fiber plies is greater than a weight of the glass fiber plies, and wherein a delaminated area of each of the specimens is equivalent to the detectability threshold,
e) performance of Compression After Impact test if Compression After Impact Test was performed in step c), Tension After Impact Test if Tension After Impact Test was performed in step c) or Shear After Impact Test if Shear After Impact Test was performed in step c), on the specimens,
f) selecting a preferred specimen as one of the specimens having a Compression After Impact equal or greater than a Compression After Impact of the reference structural part if the Compression After Impact Test was performed in steps c) and e), with a Tension After Impact equal or greater than a Tension After Impact of the reference structural part if the Tension After Impact Test was performed in steps c) and e), or with a Shear After Impact equal or greater than a Shear After Impact of the reference structural part if the Shear After Impact Test was performed in steps c) and e), and
g) determining a number of carbon glass fiber plies in the preferred specimen containing which replaced the carbon fiber plies.

3. A monolithic primary structural component of an aircraft comprising a stack of composite material plies, wherein the stack includes carbon fiber plies and at least one glass fiber ply that completely covers at least one of the carbon fiber plies and the at least one glass fiber ply is an uppermost or lowermost one of the composite material plies forming the stack.

4. A method to determine a number of glass fiber ply or plies for a monolithic primary structural part for an aircraft made of carbon fiber composite material plies and at least one glass fiber composite material plies, the method comprises:
designating as a reference structural part a carbon fiber monolithic primary structural part having of thickness greater than 3 mm, a detectability-energy curve according to a Damage Tolerance criteria and a realistic energy vertical border,
determining an impact energy for the reference structural part as a cut point between the detectability-energy curve and the realistic energy vertical border,
applying the determined impact energy to the reference structural part and thereafter performing on the reference structural part at least one of: a Compression After Impact test, a Tension After Impact Test and a Shear After Impact test on the reference structural part,
forming specimens of the reference structural part by, for each of the specimens, removing one or more external carbon fiber plies from the reference structural part and replacing the removed external carbon fiber plies with one or more external glass fiber plies, wherein a thickness of the one or more external glass fiber plies for each specimen varies between the specimens;
performing tests on the specimens, wherein the test is at least one of the Compression After Impact test if Compression After Impact Test, the Tension After Impact Test and the Shear After Impact Test;
selecting at least one of the specimens corresponding to a test result which is at least one of: a Compression After Impact result at least as great as a Compression After Impact result of the reference structural part, a Tension After Impact result at least as great as a Tension After Impact result of the reference structural, and a Shear After Impact test result at least as great as a Shear After Impact test result of the reference structural, and
determining a number of glass fiber plies added to replace the external carbon fiber plies in the selected at least one specimen.

5. The method of claim 4 wherein the specimens are formed of the same reference structural part as used to perform at least one of: a Compression After Impact test, a Tension After Impact Test and a Shear After Impact test on the reference structural part.

6. The method of claim 4 wherein the specimens are formed of the a reference structural part different than the reference structural part used to perform at least one of: a Compression After Impact test, a Tension After Impact Test and a Shear After Impact test on the reference structural part.
